(19) United States
(12) Patent Application Publication
(10) Pub. No.: US 2012/0141316 A1
(43) Pub. Date: Jun. 7, 2012

(54) GEAR ROOT GEOMETRY FOR INCREASED CARRYOVER VOLUME

(76) Inventors: David L. Wakefield, Loves Park, IL (US); Weishun Ni, Rockton, IL (US)

(21) Appl. No.: 12/960,599

(22) Filed: Dec. 6, 2010

(51) Int. Cl. F01C 1/18; F16H 55/08; B23P 15/00

(52) U.S. Cl. 418/206.1; 29/888.023; 74/460

(57) ABSTRACT

A gear includes a gear root defined by a stretched root blended into an involute tooth profile curve within a True Involute Form diameter.

### BACKGROUND

The present disclosure relates to a gear pump, and more particularly to the gear geometry thereof.

Gear pumps have historically experienced damage at the gear roots due to cavitation which occurs when local pressure falls below the fluid's vapor pressure. Formation of vapor bubbles and the subsequent collapse thereof may result in the damage.

### SUMMARY

A gear according to an exemplary aspect of the present disclosure includes a gear root defined by a stretched root blended into an involute tooth profile curve within a True Involute Form diameter.

A gear pump according to an exemplary aspect of the present disclosure includes a first and second meshed gear with a multiple of gear roots each defined by a stretched root blended into an involute tooth profile curve within a True Involute Form diameter.

A method of installing a gear within a gear pump according to an exemplary aspect of the present disclosure includes meshing a first gear with a second gear such that a gear mesh therebetween is provided with an enlarged carry-over volume greater than that provided by a standard full fillet root profile.

### BRIEF DESCRIPTION OF THE DRAWINGS

Various features will become apparent to those skilled in the art from the following detailed description of the disclosed non-limiting embodiment. The drawings that accompany the detailed description can be briefly described as follows:

FIG. 1 is a schematic view of a gear pump;

FIG. 2 is a schematic view of a mesh zone at or near the tightest mesh to backlash;

FIG. 3 is an expanded view of a gear mesh which illustrates a modified gear tooth root profile geometry versus a standard fillet root;

FIG. 4 is an expanded view of a modified gear tooth root profile with an increased carryover volume;

FIG. 5 is an expanded maximum/minimum material relationship between the modified gear tooth root profile geometry versus the standard fillet root; and

FIG. 6 is an expanded view of the modified gear tooth root profile.

### DETAILED DESCRIPTION

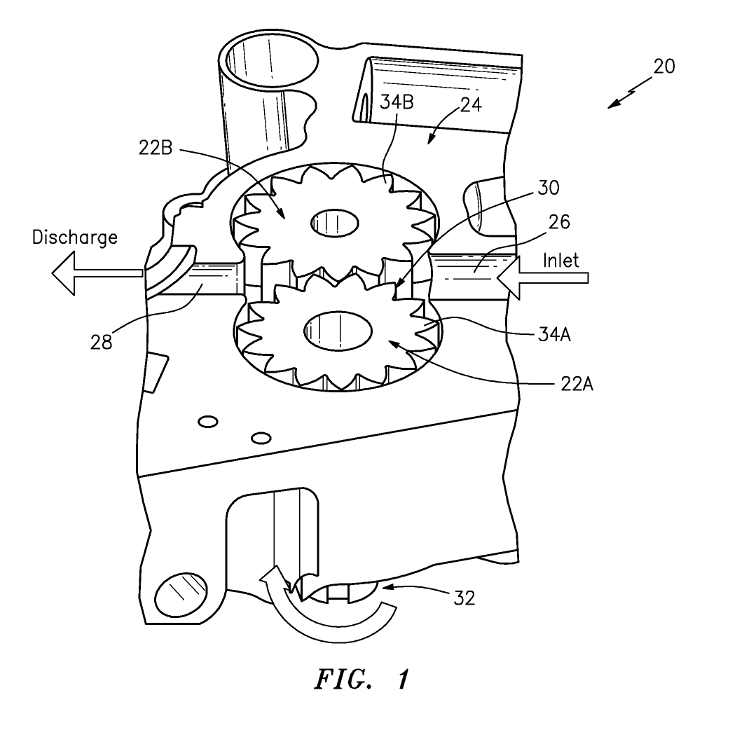

FIG. 1 schematically illustrates a gear pump 20 typical of an aerospace fluid pump operable to pump fuel, lubricant or other fluid. A pair of meshed straight-cut spur gears 22A, 22B are parallel mounted within a housing 24 having an inlet 26 and a discharge 28 in communication with a cavity 30 within which the meshed gears 22A, 22B are received. One of the meshed gears 22A is driven by an input shaft 32 which extends from the housing 24 to receive a drive input while the other gear 22B is journaled in the housing 24 as an idler and rotates because of the meshed engagement with the externally driven gear 22A. As the meshed gears rotate in opposite directions successive trapped volumes of fluid are carried by each gear 22A, 22B from the inlet 26 to the discharge 28.

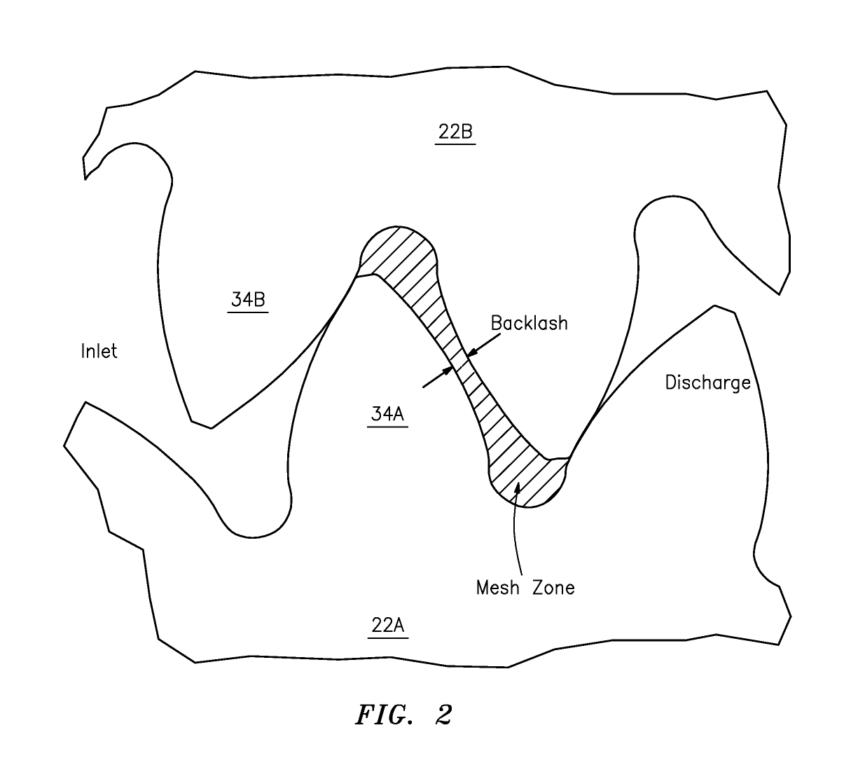

Gear teeth 34A, 34B of the gears 22A, 22B move through a mesh zone FIG. 2, which separates the pump discharge 28 from pump inlet 26. The mesh zone is defined by the contact between the gear teeth 34A, 34B which forms a seal to prevent leakage from the high pressure pump discharge 28 to the low pressure pump inlet 26. As the gears 22A, 22B enter the mesh zone, the decrease in cavity volume displaces the fluid which causes an increase in fluid pressure.

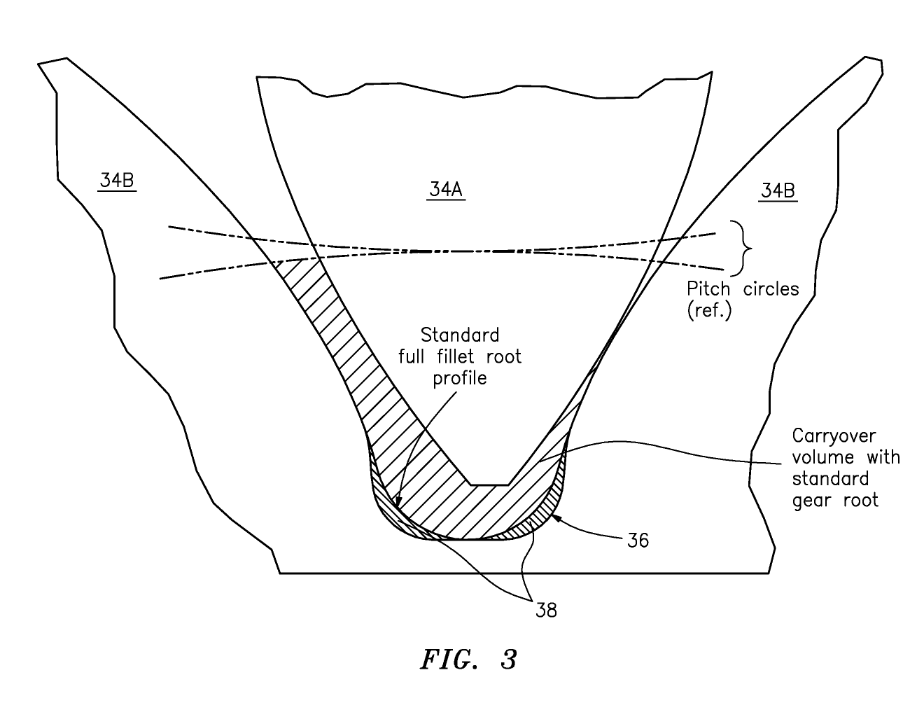

With reference to FIG. 3, at or near the point of tightest mesh to the backlash (FIG. 2), the volume between the teeth 34A, 34B is at a minimum. This minimum volume is referred to herein as carry-over (or trapped) volume, since the fluid trapped therein is carried over from discharge 28 back toward the inlet 26 because the fluid contained therein is not displaced as part of the pumped fluid to the discharge 28. Continued rotation beyond the tightest mesh minimum volume point begins to increase the volume. Fluid from the inlet must then flow into this expanding volume and fluid pressure is reduced since the energy required to induce the flow comes from the conversion of static fluid pressure into dynamic (flow) velocity energy.

During approach to the tightest mesh minimum volume point, there is some small degree of compressibility in the fluid such that the carry-over volume essentially operates as a spring to absorb some of the compression energy. Applicant has determined that an increase in the carry-over volume as compared to a standard full filet root profile increases the energy storage capability and essentially provides a larger spring. That is, an enlarged carry-over volume 38 decreases the rate of pressure increase as the gears 34A, 34B approach the tightest mesh minimum volume point. Then, as the gear teeth 34A, 34B leave the tightest mesh minimum volume point, the energy stored in the fluid is released which thereby increases the effective fluid pressure and decreases the loss of pressure within the fluid which flows in from the inlet 26.

A modified gear root geometry 36 provides the desired enlarged carry-over volume 38 as compared to a standard full fillet root profile to mitigate the effects of fluid displacement. “Standard full fillet root profile” as defined herein may be considered that which provides a constant radius which extends in a continuous arc from one tooth to the next. The typical geometry for a spur gear tooth root is a full fillet which is tangent to the involute tooth profile and simultaneously tangent to the root diameter. The lowest point of the constant radius fillet establishes the root diameter. In the case of hobbed gears, the geometry is generated by the path the tool tip follows as the teeth are cut. For form ground teeth, the radius is formed on the extremity of the grinding wheel. The adjacent sides of two teeth and the root between them is formed at the same time by the grinding wheel that conforms to the net finished profile of the space between the teeth.

The effects from the enlarged carry-over volume 38 of the modified gear root geometry 36 tend to reduce the phenomenon of cavitation within the gear mesh zone. A reduction in the dynamic pressure loss on the inlet side of the trapped volume increases the available static pressure which reduces the tendency to form bubbles within the fluid due to the fall of the local fluid pressure below the fluid's true vapor pressure (TVP) and suppresses bubble formation. Suppression of bubble formation reduces the incidence of cavitation. The reduced pressure spike generated in the trapped volume as the teeth approach the tightest mesh minimum volume point in turn reduces the total energy which collapses any bubbles that may have formed. This decreases the cavitation erosion power and the severity of damage if cavitation does occur.

In one non-limiting embodiment, the enlarged carry-over volume 38 provides an approximate 7% increase as compared to the standard full fillet root profile. It should be understood that the magnitude of increase may be greater or smaller dependent upon the actual gear geometry and the practical manufacturing tolerances.

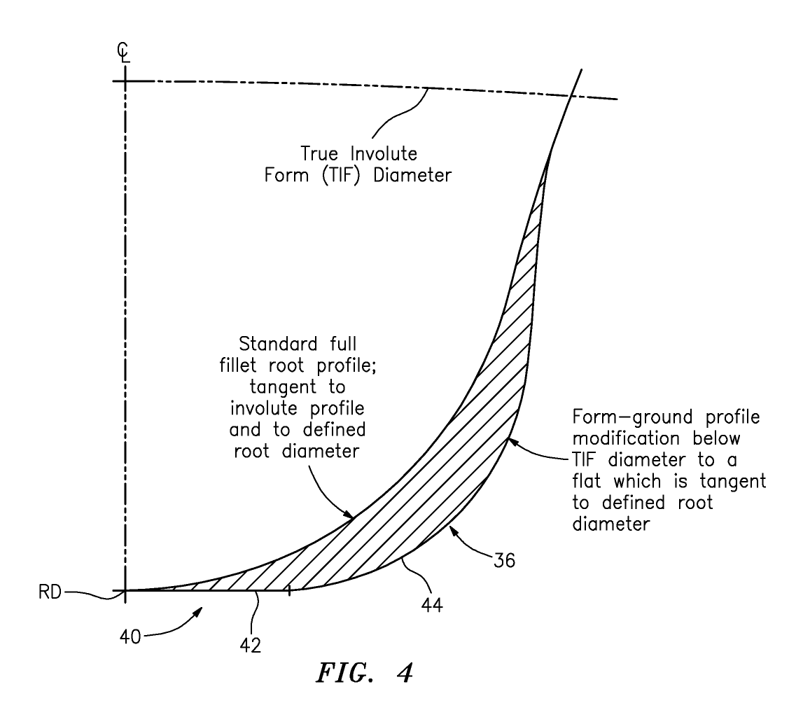

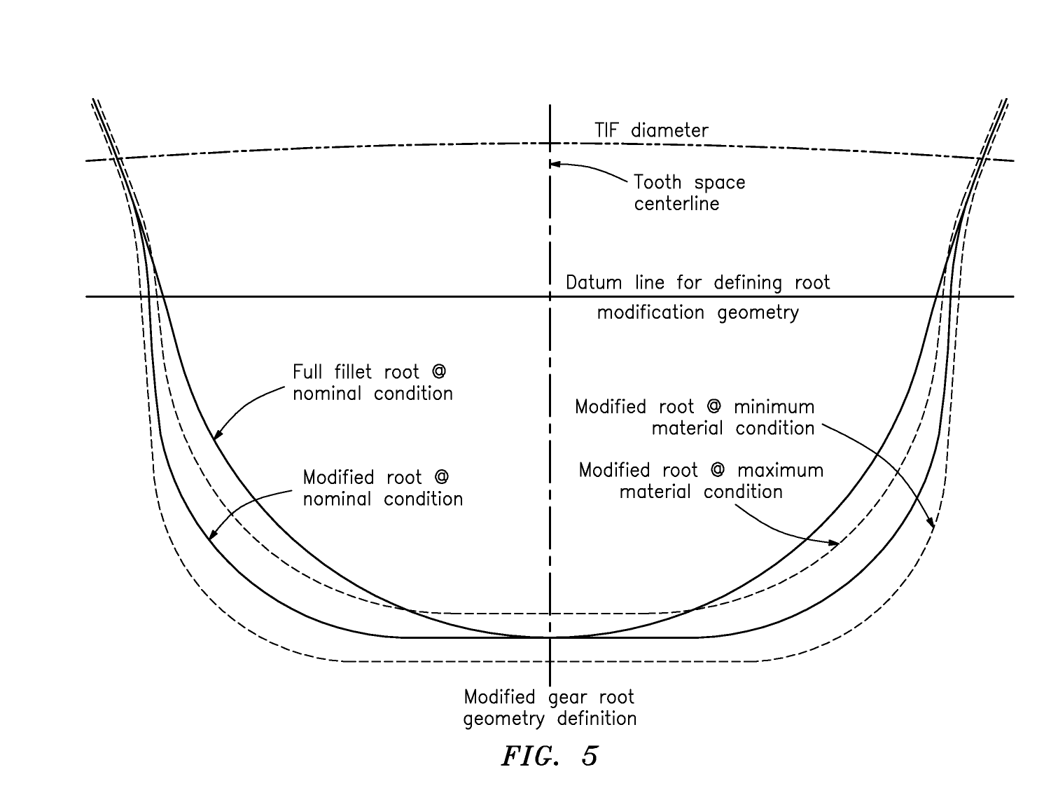

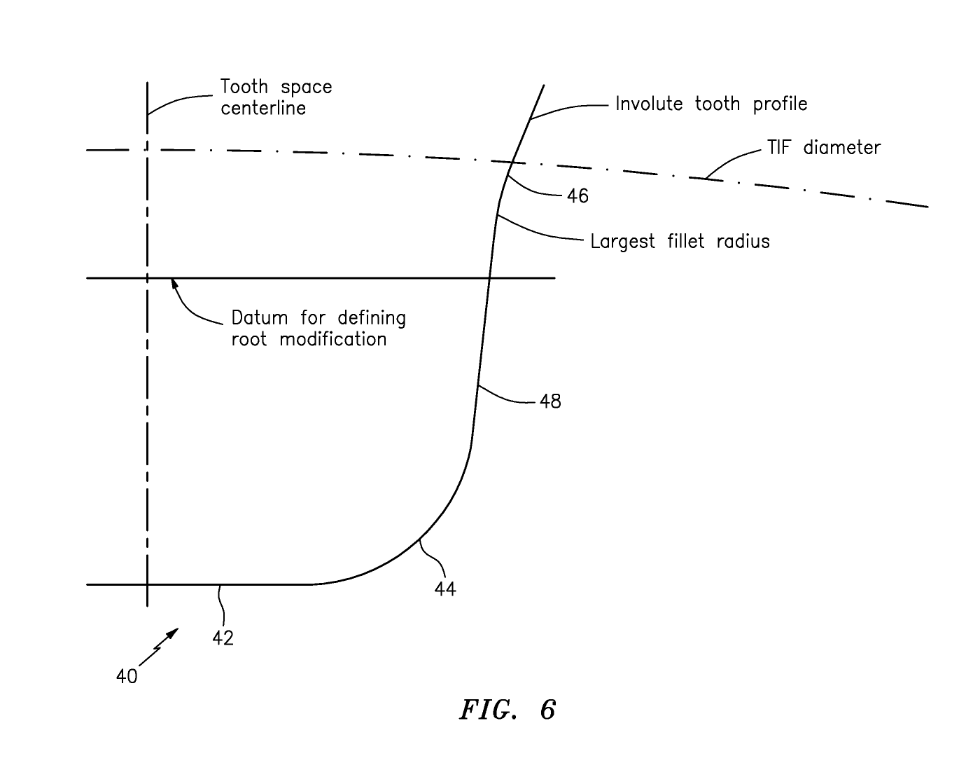

With reference to FIG. 4, the enlarged carry-over volume 38 may be defined within each gear root 40 by stretching the root circumferentially at the root diameter to form a root flat 42 which extends tangent to the defined root diameter RD from the tooth centerline CL then blended at a blend 44 into the involute tooth profile curve within the True Involute Form (TIF) diameter (FIG. 5). That is, the gear root 40 is defined by a stretched root blended into a flat side 48 at the widest possible spacing and shallowest angle toward zero for maximum carry-over volume, which may be blended into the specified involute tooth profile curve at a fillet radius 46 located within the True Involute Form (TIF) diameter to ensure proper gear tooth meshing action (FIG. 6).

To maximize the increase in root carry-over volume 38, the tangent point between the fillet radius 46 and the specified involute tooth profile curve is located as close to the True Involute Form (TIF) diameter as possible with a minimization of the tolerances on the width of the root modification (FIG. 5). As the modified gear root geometry 36 must not extend beyond the True Involute Form (TIF) diameter. That is, the modified gear root geometry 36 is constrained radially within the True Involute Form (TIF) diameter.

It should be understood that although the root flat 42 is illustrated in the disclosed non-limiting embodiment, other extensions from the defined root diameter RD which do not extend radially inward thereof may alternatively be provided. It should be understood, however, that various blend profiles to include multiple segments, undercuts and other geometry which provide the enlarged carry-over volume 38 may alternatively or additionally be provided.

It should be understood that like reference numerals identify corresponding or similar elements throughout the several drawings. It should also be understood that although a particular component arrangement is disclosed in the illustrated embodiment, other arrangements will benefit herefrom.

Although particular step sequences are shown, described, and claimed, it should be understood that steps may be performed in any order, separated or combined unless otherwise indicated and will still benefit from the present disclosure.

The foregoing description is exemplary rather than defined by the limitations within. Various non-limiting embodiments are disclosed herein, however, one of ordinary skill in the art would recognize that various modifications and variations in light of the above teachings will fall within the scope of the appended claims. It is therefore to be understood that within the scope of the appended claims, the disclosure may be practiced other than as specifically described. For that reason the appended claims should be studied to determine true scope and content.

What is claimed is:

1. A gear comprising:
a gear root defined by a stretched root blended into an involute tooth profile curve within a True Involute Form diameter.

2. The gear as recited in claim 1, wherein said stretched root is blended into said involute tooth profile curve through a form-ground profile modification.

3. The gear as recited in claim 1, wherein said stretched root includes a flat.

4. The gear as recited in claim 1, wherein said stretched root includes a flat perpendicular to a tooth space centerline.

5. The gear as recited in claim 1, wherein said stretched root defines a flat which is tangent to a root diameter.

6. The gear as recited in claim 1, wherein said stretched root is circumferentially stretched.

7. The gear as recited in claim 1, wherein a root diameter of said gear root defines an innermost bound and said True Involute Form diameter defines an outer bound of an area of said gear root.

8. A gear pump comprising:
a first gear with a multiple of first gear roots each defined by a stretched root blended into an involute tooth profile curve within a True Involute Form diameter; and
a second gear meshed with said first gear, said second gear defines a multiple of second gear roots each defined by a stretched root blended into an involute tooth profile curve within a True Involute Form diameter.

9. The gear pump as recited in claim 8, wherein said multiple of first gear roots are identical to said multiple of second gear roots.

10. A method of installing a gear within a gear pump comprising:
meshing a first gear with a second gear such that a gear mesh therebetween is provided with an enlarged carry-over volume greater than that provided by a standard full fillet root profile.

11. A method as recited in claim 10, wherein the enlarged carry-over volume is defined by stretching a root diameter of a gear root tangent to a defined root diameter.

12. A method as recited in claim 11, further comprising blending the gear root into an involute tooth profile within a True Involute Form diameter

13. A method as recited in claim 10, wherein the enlarged carry-over volume is bounded by a root diameter and a True Involute Form diameter.

14. A method as recited in claim 10, wherein the enlarged carry-over volume is defined by stretching a root of a gear root and blending into an involute tooth profile.
